(19) United States
(12) Patent Application Publication
(10) Pub. No.: US 2009/0013141 A1
(43) Pub. Date: Jan. 8, 2009

(54) Information leakage detection for storage systems

(76) Inventor: Junji Kinoshita, Sunnyvale, CA (US)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/822,131

(22) Filed: Jul. 2, 2007

(51) Int. Cl. G06F 12/14

(52) U.S. Cl. 711/163; 711/E12.091

(57) ABSTRACT

A storage system compares content of new data received from a host computer with content of existing data already stored in the storage system. If the content of the new data matches the content of the existing data, the storage system determines whether the computer that sent the new data is a registered owner of the new data by determining who the registered owners are of the existing data that has the matching content. If the computer that sent the new data is not a registered owner, unauthorized information sharing is assumed to have taken place. The storage system sends a notification or takes other specified action when the computer that sent the new data is not a registered owner. An administrator or monitoring agent may thus be notified of any unauthorized file sharing or data leakage within the storage system.

### BACKGROUND OF THE INVENTION

1. Field of the Invention

The present invention relates generally to storage systems and information systems that store data.

2. Description of Related Art

Most companies or organizations have a certain amount of confidential data stored in their information systems. In general, it is difficult to control data flow in information systems because it is very easy for users with authorized access to copy and distribute electronic data. As a result, confidential information contained within electronic data is likely to be distributed to many places inside and outside of organizations. Such situations can cause both unintentional information leakage and also provide the opportunity for intentional misappropriation of confidential information.

To prevent information leakage and protect privacy information, many different regulations have been established in recent years. Companies and organizations need to be compliant to such regulations. To meet compliance and achieve internal control, many companies and organizations have strict security policies or rules for their employees. However, it is often difficult to enforce these policies and rules over an entire organization, especially in large organizations with many employees and a number of different divisions, groups, databases, and the like. Thus, it is not easy for those in charge of enforcing these rule and policies to detect violations when they take place. As a result, confidential data is likely to be scattered around inside organizations in spite of rules and policies intended to prevent this. Accordingly, it would be desirable to have an automated system in place that detects when a leakage of protected information has occurred, that is able to notify those in charge of the leakage, and that is also able to take corrective measures.

Additionally, it is known in the prior art to conduct de-duplication on data for reducing the amount of data stored in a storage system. For example, U.S. Pat. No. 7,065,619, to Zhu et al., entitled “Efficient Data Storage System”, filed Dec. 20, 2002, the disclosure of which is incorporated herein by reference, teaches de-duplication operations using a summary in a low latency memory. However, the prior art does not teach or suggest an information leakage detection technique that leverages a data de-duplication functionality.

### BRIEF SUMMARY OF THE INVENTION

The invention detects possible information leakage in an information system, such as, for example, unauthorized information sharing among several different divisions or groups of an organization that use a consolidated storage system. The invention is further able to notify security monitoring services of an information leakage and/or take corrective action when the storage system detects an information leakage. These and other features and advantages of the present invention will become apparent to those of ordinary skill in the art in view of the following detailed description of the preferred embodiments.

### BRIEF DESCRIPTION OF THE DRAWINGS

The accompanying drawings, in conjunction with the general description given above, and the detailed description of the preferred embodiments given below, serve to illustrate and explain the principles of the preferred embodiments of the best mode of the invention presently contemplated.

FIG. 1 illustrates an example of a hardware structure in which the present invention may be practiced.

FIG. 2 illustrates an exemplary software structure of the invention as implemented on the hardware structure of FIG. 1.

FIG. 3A illustrates an exemplary network file system service command unit.

FIG. 3B illustrates an exemplary file data structure.

FIG. 4 illustrates an exemplary host group definition table.

FIG. 5 illustrates an exemplary host table.

FIG. 6 illustrates an exemplary file table.

FIG. 7 illustrates an exemplary action table.

FIG. 8 illustrates an exemplary action definition table.

FIG. 9 illustrates a management graphic user interface.

FIG. 10 illustrates a process to dispatch a command.

FIG. 11 illustrates a synchronous process to detect information leakage.

FIG. 12 illustrates a process to execute actions.

FIG. 13 illustrates a process to add a new host and change an action using the management interface.

FIG. 14 illustrates an asynchronous process to detect information leakage.

FIG. 15 illustrates an exemplary hardware structure of the second embodiments of the invention.

FIG. 16 illustrates an exemplary software structure of the second embodiments of the invention.

FIG. 17 illustrates a SCSI command unit.

FIG. 18 illustrates a process to dispatch I/O operations.

FIG. 19 illustrates a synchronous process to detect information leakage in the second embodiments.

### DETAILED DESCRIPTION OF THE INVENTION

In the following detailed description of the invention, reference is made to the accompanying drawings which form a part of the disclosure, and, in which are shown by way of illustration, and not of limitation, specific embodiments by which the invention may be practiced. In the drawings, like numerals describe substantially similar components throughout the several views. Further, the drawings, the foregoing discussion, and following description are exemplary and explanatory only, and are not intended to limit the scope of the invention or this application in any manner.

The information leakage system of the invention may be applied in numerous different types of information systems, such as storage systems including NAS (network attached storage) systems, DAS (direct access storage) systems, block-based storage systems, CAS (content addressed storage) systems and other types of storage systems including those using a LAN (Local Area Network), a SAN (Storage Area Network) or other internal or external network types for communicating information. In some embodiments, the information leakage detection system of this invention detects information leakage by having the storage system determine the owners of data stored in the storage system. A host computer that primarily stores data in the storage system can become an owner of the data. An administrator is able to change the owner of the data and add one or more other host computers or host groups as owners of the data using a management interface of the storage system. In some embodiments, when the storage system receives data from a host computer, the storage system checks whether the host computer is the owner of the data. If the host computer is not the owner of the data, the storage system executes a specified or predetermined action. The storage system can execute several kinds of actions, including sending a notification of an information leakage to an administrator at a management computer. Further, an administrator can configure the actions for each type of data. The system can be used with both file-based data and block-based data. In other embodiments, the storage system is also able to check the owners of data asynchronously. Under the asynchronous technique, the storage system scans its file system periodically, finds new files that have been stored since the last scan, and determines the ownership of the new files.

Thus, the invention enables a storage system to detect and notify a management host when new data is stored in the storage system that has the same content as existing data previously stored in the storage system, whether or not the new data has the same file name or data identifier as the existing data. In some embodiments, hash values are calculated for the new data and compared with hash values calculated for the existing data to quickly determine whether the content of the new data is the same as the content for the existing data. The storage system is then able to determine if the owner of the new data is registered as an owner of the existing data, and identify an information leakage occurrence when the ownership does not correlate.

The invention enables an administrator or monitoring agent to be notified of any suspicious or unauthorized file sharing or data leakage within the storage system. This unauthorized sharing often occurs through attachments to e-mails, use of mobile storage mediums, such as USB flash memory, or the like. The invention may be used in a storage system in addition to other security measures, such as access control software that prevents an unauthorized user from accessing certain files, volumes or partitions within the storage system. Thus, the present invention is able to fill a gap in security protection, and is able to detect instances in which data is shared by means other than direct unauthorized access to the original files. The invention is able to detect that this sharing took place even though unauthorized access to the confidential data never occurred. When such unauthorized information sharing takes place, and the shared data is stored back into the storage system, even under a different name, the invention is able to detect this and take an action. The invention is able to perform this detection function synchronously, as the data is attempted to be stored to the storage system, or asynchronously, after the data has already been stored.

### FIRST EMBODIMENTS

### Hardware Architecture

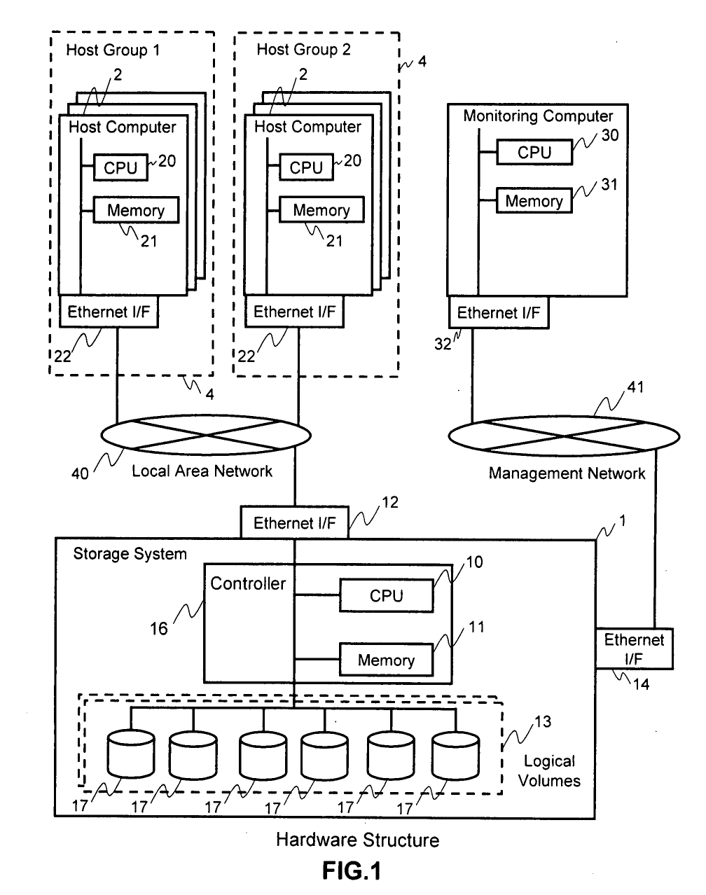

FIG. 1 illustrates an example of a physical hardware architecture of an information system in which the first embodiments of the invention may be implemented. In the first embodiments, the information system includes a storage system 1 in communication with one or more host computers 2, and also in communication with one or more monitoring computers 3. Each host computer and storage system can be connected through a LAN (Local Area Network) 40, although the invention is not limited to any particular network or connection type. Monitoring computer 3 and storage system 1 can be connected through a separate management network 41. But in alternative embodiments, they may be connected through LAN 40 or other communication link. Each host computer 2 may further be a member of at least one host group 4, as will be described in greater detail below.

Storage system 1 includes a controller 16 that includes at least one CPU (central processing unit) 10, at least one memory 11, and two Ethernet interfaces 12 and 14 that are used for connecting to LAN 40 and management network 41, respectively. Storage controller controls input/output (I/O) operations to one or more storage devices 17. Storage devices 17 are hard disk drives in the preferred embodiment, but in other embodiments may be solid state memory devices, optical devices, tape devices, or the like. One or more of storage devices 17 may be logically configured to create one or more logical volumes 13. For example, each logical volume 13 may be composed from portions of a plurality of physical storage devices 17 arranged in a RAID (redundant array of independent disks) array, such that data stored to a logical block address (LBA) in the volume 13 is physically stored to the storage devices 17, as is known in the art. Further, in the case of the storage of file data, file systems or portions thereof may be created on the volumes 13 to enable storage of file-based data.

Each host computer 2 includes at least one CPU 20, at least one memory 21, and at least one Ethernet interface 22 to enable connection to LAN 40. Additionally, each monitoring computer 3 includes at least one CPU 30, at least one memory 31, and at least one Ethernet interface 32, or the like, to enable connection of management computer 3 to management network 41. Each host computer 2 may be designated as belonging to one or more host groups, as described further below.

Software Architecture

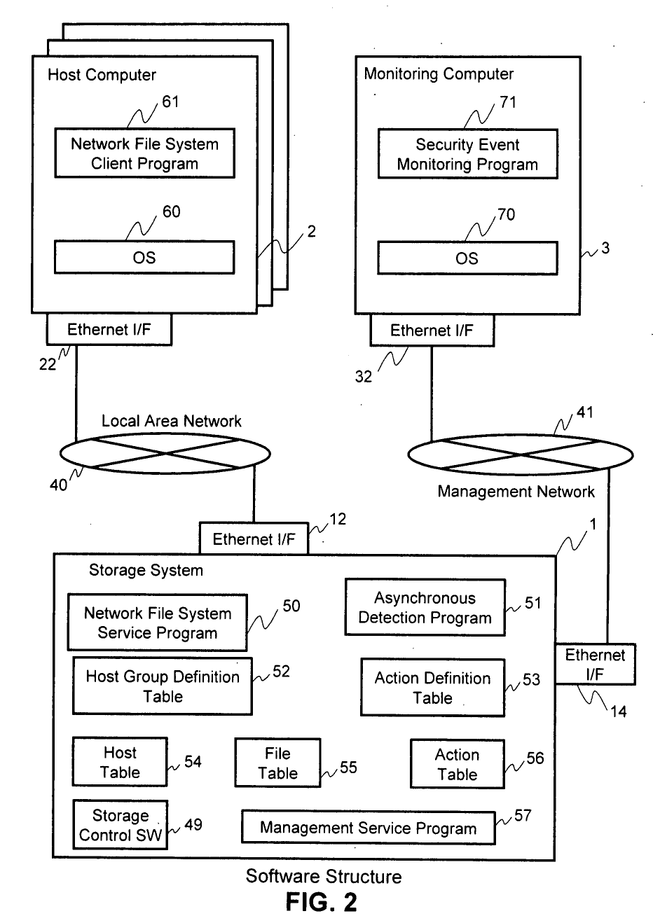

FIG. 2 illustrates an example of a logical software architecture of the first embodiments. Software on storage system 1 may be stored in memory 11 or other computer readable medium, and executed by CPU 10. Software on storage system 1 includes a network file system service program 50. Service program 50 provides network file system service (such as NFS, CIFS or the like) to host computer 2. For example, service program 50 exports part of its own file system to host computer 2. The file system and related functions are provided by storage control software (SW) 49 that acts as the operating system for storage system 1.

Storage system 1 can implement both a synchronous and an asynchronous way to detect information leakage. In the case of the synchronous method of leakage detection, storage system 1 carries out a process to detect information leakage in synchronization with a process for receiving files from the host computers 2. In this embodiment, service program 50 performs not only network file system services, but also performs the process to detect information leakage synchronously. When service program 50 receives a file from a host computer 2, service program 50 checks whether the same file has already been stored within storage system 1 by another host computer 2. Service program 50 is also able to check whether the same file has already been registered for another host computer by the administrator. If the same file was already stored or registered, service program 50 executes an action, as described below. In these embodiments, service program 50 uses hash values calculated for each file to compare files, although other comparison means, such as algorithms other than hash calculations, direct comparison, or the like, may also be used. Typical hash algorithms that can be used with the invention include MDX (Message Digest algorithm) and SHA (Secure Hash Algorithm), but the invention is hot limited to any particular hashing algorithm.

Asynchronous detection program 51 is applied in the case in which asynchronous detection is carried out. Thus, under the asynchronous detection process, storage system 1 executes asynchronous detection program 51 to detect information leakage separately from the process carried out by the service program 50. In this embodiment, asynchronous detection program 51 periodically checks whether there is any new file stored within storage system 1, and checks whether the same file was already stored within storage system 1. If the same data content has already been stored, then asynchronous detection program 51 executes a specified action as described further below. Asynchronous detection program 51 uses hash values of files to compare files in the preferred embodiments, but could use algorithms other than hash, or other comparison means.

Host group definition table 52 holds group definition information of host computers. When storage system 1 performs the process to detect information leakage, it can group multiple host computers together using host groups 4, as also illustrated in FIG. 1. Using host groups 4, an administrator can easily manage a number of host computers 2. Thus, a host computer 2 may belong to its own host group 4 if it is the only computer in that group, or a host computer may belong to any number of host groups, with each group having any number of host computers belonging to it. Typically, however, in a large organization, a host computer might belong to only one host group, such as the host group for one division of the organization, whereby each division has its own host group made up of the host computers belonging to that division. Although, it should be noted that the invention applies equally as well if individual host computers are registered, rather than host groups, and the invention is not limited to using host groups.

Action definition table 53 holds definitions of actions that are executed by service program 50 or asynchronous detection program 51 when they detect information leakage. There could be many kinds of actions such as logging, mail, SNMP Trap, or the like. Administrators can configure this table via management service program 57.

Host table 54 holds hash values of existing files and host groups that are registered as owners of the existing files. Using this table, service program 50 and asynchronous detection program 51 checks whether a certain new file is already stored within the storage system as an existing file. It is also possible to check the owners of the existing files using this table. Host groups listed for each hash value of the files in this table are owners of the existing files. The first host group that stored the file usually becomes the owner of the file. However, administrators can configure this table via management service program 57 to add or remove owners of files, as is described further below.

File table 55 holds hash values of files and identifications of files (such as names of files, names of file-paths, or so). Multiple identifications could indicate the same file.

Action table 56 holds hash values of files and identifications of actions. When service program 50 and asynchronous detection program 51 detect information leakage, they execute actions indicated by the identifications. Actual actions are defined within action definition table 53-56.

Management service program 57 provides administrators with a graphic management interface for managing storage system 1. Using this interface, administrators can execute various kinds of management operations, including detection of information leakage. For example, administrators can view or configure host group definitions, action definitions, and the like.

Host computer 2 includes an operating system (OS) 60 and a network file system client program 61. OS 60 is software used to provide interfaces of hardware control to application software and enable file system access. Client program 61 enables host computer 2 to utilize the file system that is exported by service program 50.

Software on the monitoring computer 3 includes an OS 70 and a security event monitoring program 71. OS 70 is software used to provide interfaces of hardware control to application software. Security event monitoring program 71 receives messages from service program 50 and asynchronous detection program 51 when these programs execute actions. For example, these programs can send some kind of messages to security event monitoring program 71 to provide notification of the occurrence of information leakage.

Data Structures

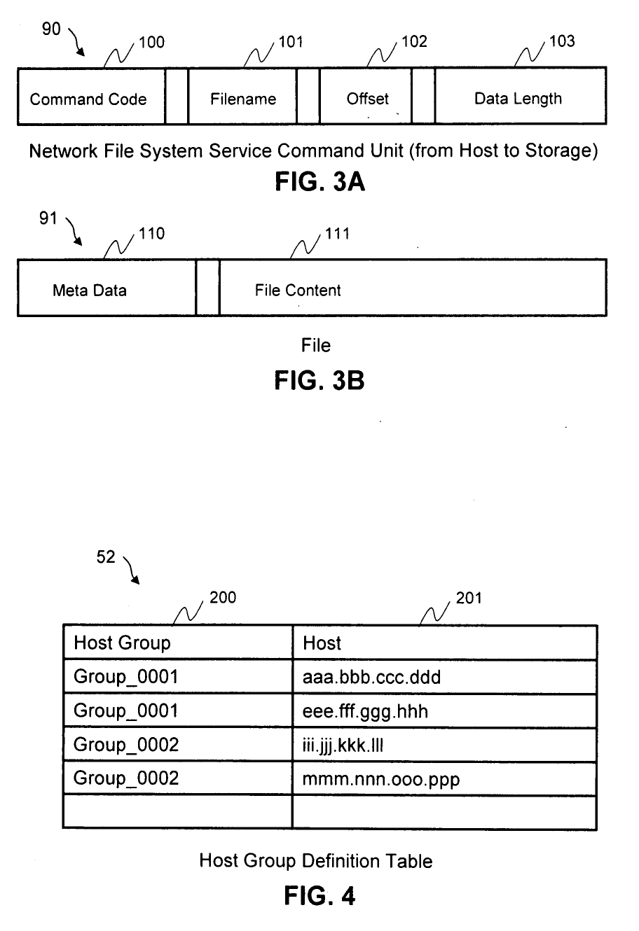

Host computers 2 and storage system 1 communicate with each other via LAN using a network file system service protocol (such as CIFS, NFS, or the like). Host computers 2 issue requests using a network file system service command unit 90, and then host computers 2 are able to transmit data to the storage system or receive data from the storage system. FIG. 3A illustrates an example data structure of network file system service command unit 90. A command code 100 indicates a type of request sent from the host computer (for example, Read, Write, etc.). A filename 101 indicates a name of a file. Host computers specify the filename within network file system service command unit 90, and then data of the file specified by the name is transferred between host computers 2 and storage system 1. Offset 102 indicates an offset address from the beginning of the file specified by the filename. Data Length 103 indicates the data length of the data that is transferred between a host computer and a storage system in response to network file system service command unit 90.

FIG. 3B illustrates an example data structure of a file 91 that is stored to storage system 1. Meta Data 110 indicates an area that is mainly used by operating systems and storage system 1. File content 111 indicates an area that is mainly used to store user data. When service program 50 or asynchronous detection program 51 on storage system 1 calculate hash values of files in this embodiment, they calculate hash values of the file content 111.

FIG. 4 illustrates an example data structure of a host group definition table 52. In host group definition table 52, a host group field 200 indicates identifications of groups to which host computers belong, and a host field 201 indicates identifications of particular host computers. When a file or other data is sent to storage system 1, the storage system is able to determine the sender of the file from an IP address or the like, and determine from the host group definition table 52, the identity of the host or host group. This information is then used to determine ownership of the newly-sent data for comparison with the registered owners, as described further below.

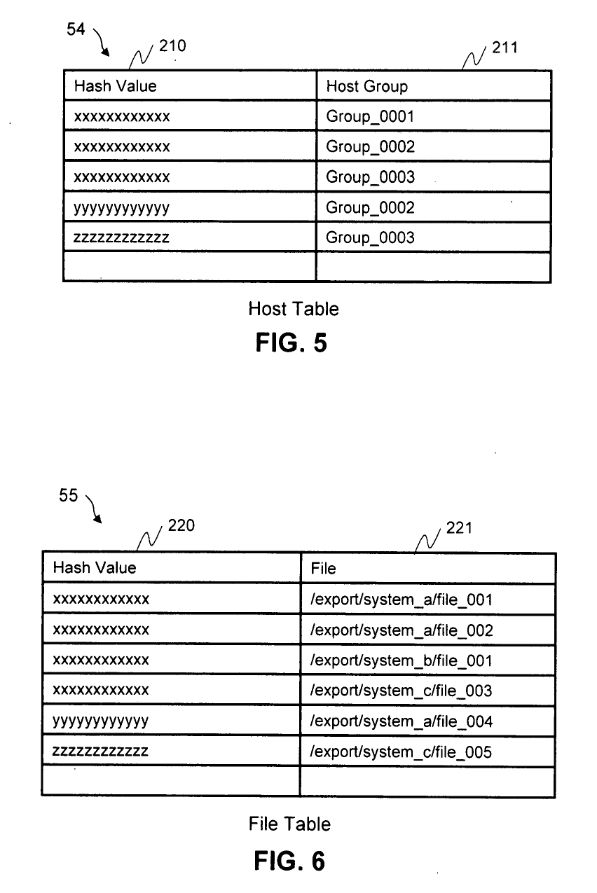

FIG. 5 illustrates an example data structure of host table 54. In host table 54, a hash value field 210 indicates hash values calculated for various files in the storage system. A host group field 211 indicates an identification of a group 4 of host computers that are owners of the files.

FIG. 6 illustrates an example data structure of file table 55. In file table 55, a hash value field 220 indicates hash values of various files in the storage system 1. A file field 221 indicates an identification of a file. Identification of a file could be a name of the file, a file path of the file that indicates a location of the file within the file system of the storage system 1, file handle, or the like. In this embodiment, file field 221 contains a file path of the file, thereby indicating directly where the filed is stored. Thus, the invention is able to incorporate data de-duplication since it enables the identification of duplicate data stored in the storage system. As illustrated in FIG. 6, files having the same data may be stored under a plurality of different file paths, but the data need only be stored the first time. Additional paths may be entered in file table 55, such as for hash value “xxxxxxxxxxxx”, which has four entries with four different paths. The storage system can access the file through the first path listed when a request is made to any of the four paths. When a Host Computer changes the data in the first path, the storage system stores the new data and registers the new hash value in the file table 55. With respect to the old data, the first path entry is removed from file table 55, and the second path in file table 55, if any, will now point to the old data.

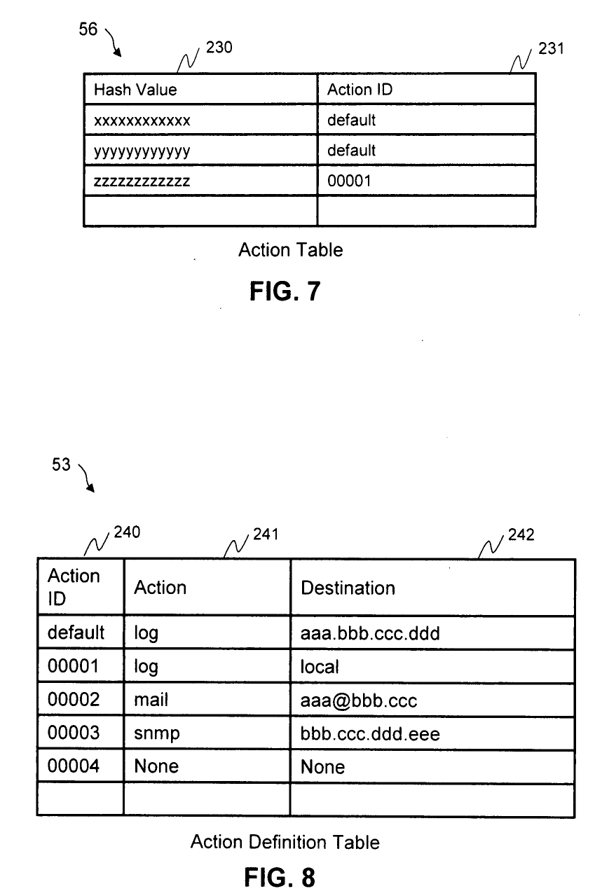

FIG. 7 illustrates an example data structure of action table 56. In action table 56, a hash value 230 indicates hash values of a file. An action ID 231 indicates an identification of an action that is executed by service program 50 or asynchronous detection program 51 when a leakage is detected. Each specific action is defined within action definition table 53, as discussed below.

FIG. 8 illustrates an example data structure of action definition table 53. In action definition table 53, an action ID field 240 indicates an identification of an action that is executed by service program 50 or asynchronous detection program 51. An action field 241 indicates a name of a particular action that is executed by service program 50 or asynchronous detection program 51. There could be various kinds of actions such as logging, mail, SNMP Trap, or so. A destination field 242 indicates a destination of an event message that is issued by service program 50 or asynchronous detection program 51. When information leakage is detected, the programs 50, 51 send an event message to security event monitoring program 71 to notify the event monitoring program 71, and thereby the administrator, of an occurrence of information leakage. The destination could be any of various kinds of information such as an e-mail address, IP address, or the like.

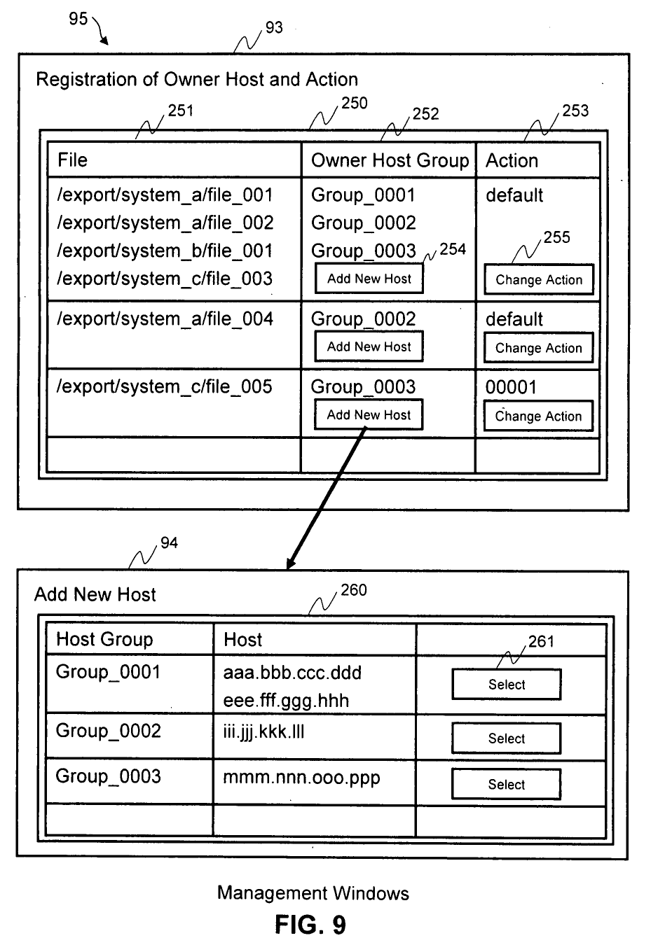

FIG. 9 illustrates an example of graphic user interface that includes a management window 93 that is displayed to administrators via a management interface 95 using management service program 57. In management window 93, there is displayed a registration table 250 that is used for registering owner host computers and actions for files. In registration table 250, a file field 251 contains a list of file paths that indicates the same file (i.e., a file that contains the same content, even though the name and path is different. Management service program 57 retrieves file information from file table 55 to create this portion of registration table 250. An owner host group field 252 indicates a list of identifications of host groups associated with the files in file field 251. Management service program 57 retrieves host group information from host table 54 for creating this portion of registration table 250. An action field 253 indicates an action that is executed by service program 50 or asynchronous detection program 51 when information leakage is detected. Management service program 57 retrieves action information from action table 56 for creating this portion of registration table 250.

Management window 93 of FIG. 9 includes one or more interactive buttons for enabling an administrator to accomplish certain management tasks. An Add New Host button 254 enables the addition of a new host group as an owner of data. Thus, when an administrator activates the Add New Host button 254, a second management window 94 opens, and the administrator is able to add a new host group into the list of owner host groups using an Add New Host table 260. Add New Host table 260 includes a Select button 261 which, when activated by the administrator for a particular host group 4, causes management service program 57 to register the particular host group on host table 54, which will also add the host group to registration table 250. Also a Change Action button 255 is included in registration table 250. When an administrator activates the Change Action button 255, an action for the file can be changed to a different action by selecting from a list of available actions.

Process Flows

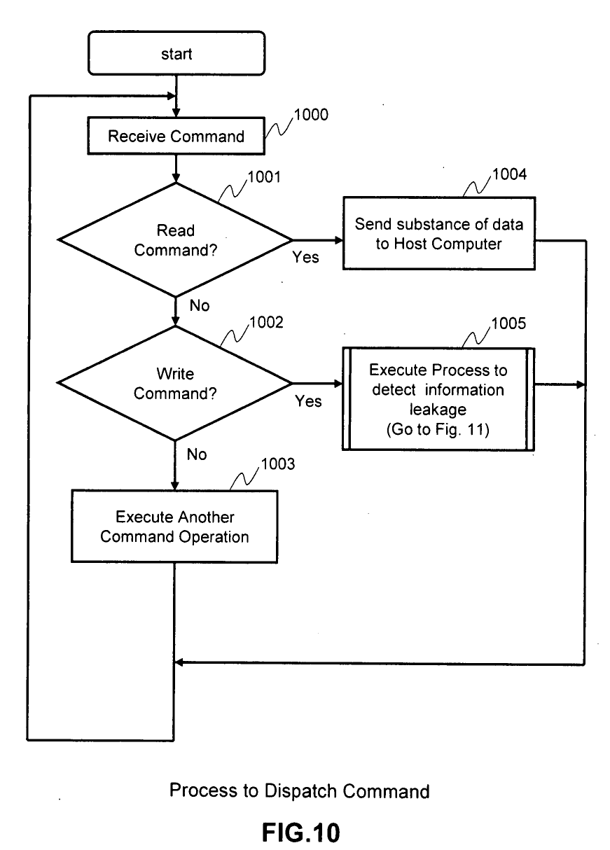

FIG. 10 illustrates an example process for dispatching a network file system service command 90 received by storage system 1 and executed by service program 50.

Step 1000: Service program 50 receives network file system service command unit 90 from a host computer 2.

Step 1001: Service program 50 checks whether the command is a Read command. If the command is a Read command then the process goes to Step 1004; otherwise, the process goes to Step 1002.

Step 1002: If the command is not a Read command, service program 50 checks whether the command is a Write command. If the command is a Write command, the process goes to Step 1005; otherwise, the process goes to Step 1003.

Step 1003: The command is neither a Read command, nor a Write command, so since the service program 50 executes commands other than Read and Write commands, the command is executed and the process goes on to receive and check the next command.

Step 1004: Service program 50 refers to file table 55. If file table 55 includes a name of a file that was requested by the host computer, service program 50 sends data that corresponds to the data requested by the host computer.

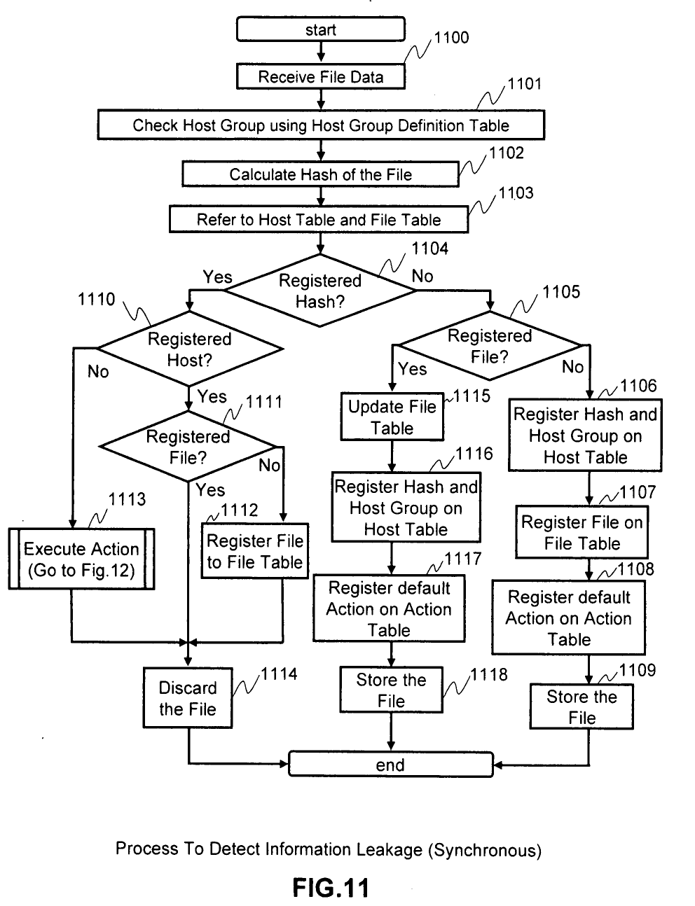

Step 1005: The command was determined to be a Write command, so the service program 50 executes a process to detect information leakage, as described in detail below with respect to FIG. 11.

FIG. 11 illustrates an exemplary process for detecting information leakage executed by service program 50. This process is carried out in what is referred to herein as a synchronous manner, since the process is carried out when a Write request is received by the storage system and the data is saved in the storage system 1.

Step 1100: Service program 50 receives data from host computer 2.

Step 1101: Service program 50 determines the host group of the host computer that sent the file to storage system 1 using host group definition table 52.

Step 1102: Service program 50 calculates a hash value for the file received in Step 1101.

Step 1103: Service program 50 refers to host table 54 and file table 55.

Step 1104: Service program 50 checks whether the hash value calculated in Step 1102 is the same as any hash values already registered on host table 54. If the hash value is already registered on the host table 54, then the process goes to Step 1109. Otherwise, if the hash value is not registered on the host table 54, the process goes to Step 1105.

Step 1105: When the hash value is not already registered on the host table 54, service program 50 next checks whether the file path of the file is already registered for another hash value on file table 55. If the file path of the file is already registered for the other hash vale on the table then the process goes to Step 1115. Otherwise, when the file path also is not registered, then the process goes to Step 1106.

Step 1106: Service program 50 registers the hash value calculated in Step 1102 and the host group determined in Step 1101 on host table 54, since the process assumes that the data of the file received in step 1101 is not already saved in the storage system and that the host that saved the file is the authorized owner. Accordingly, this step registers the file as being owned by the host group of the host computer that sent the Write request. Thus, the first host group to save a new file to the storage system is usually presumed to be the owner of the file.

Step 1107: Service program 50 registers the hash value of the file and the file path of the file on file table 55.

Step 1108: Service program 50 registers the hash value of the file and a default action on action table 56.

Step 1109: Service program 50 stores the file within storage system 1.

Step 1110: When the hash value calculated in Step 1102 is the same as a hash value that is already registered in host table 54, service program 50 checks whether the host group of the host computer that sent the file (as identified in Step 1101) is already registered for the hash value on host table 54. If the host group is already registered for the hash value on the table then the process goes to Step 1111. Otherwise, if the host group is not registered for that hash value, then information leakage is assumed, and the process goes to Step 1113 to execute an action.

Step 1111: Service program 50 checks whether the file path of the file is already registered for the hash value on file table 55. If the file path of the file is already registered for the hash value on the table, then the process goes to Step 1114. Otherwise, if the file path is not already registered for the hash value, the process goes to Step 1112.

Step 1112: Service program 50 registers the file path of the file for the hash value on file table 55.

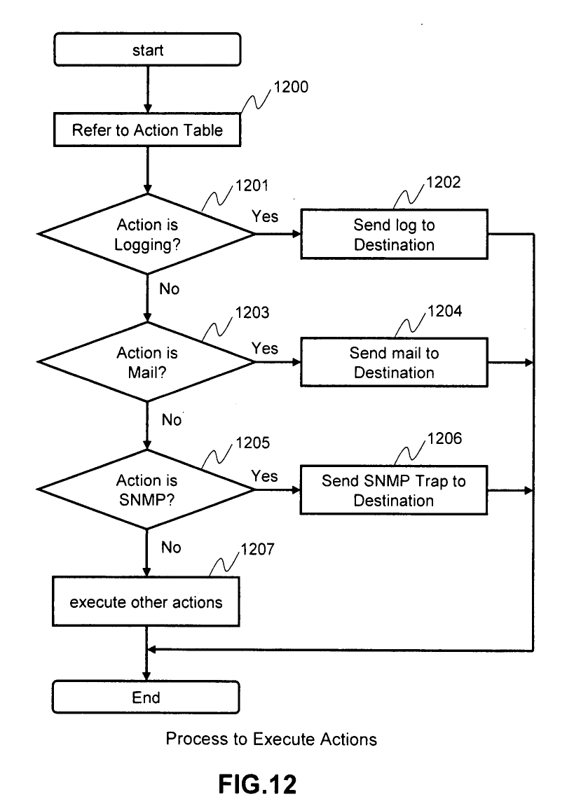

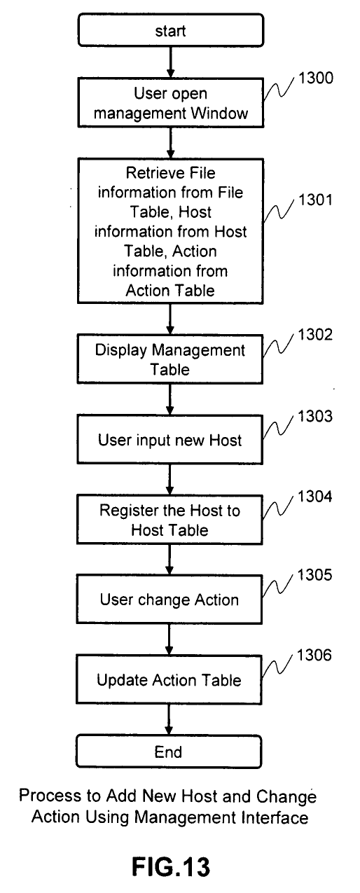

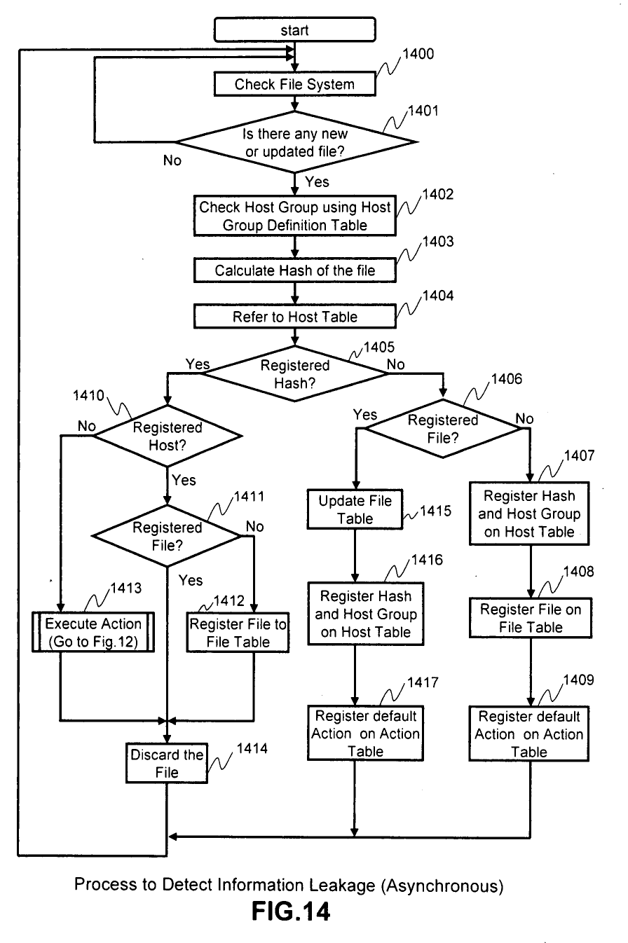

Step 1113: Service program 50 executes the process to execute actions, as detailed in FIG. 12.

Step 1114: Service program 50 discards the file data, since the same data is already stored in another location in the storage system. Further, a direct comparison of the data (e.g., bit-to-bit, or the like) may be conducted here or earlier in order to ensure that the data already stored on the storage system is exactly the same as the data to be discarded before the data is actually discarded. This can eliminate the slim possibility of having matching hash codes for different actual data.

Step 1115: When the hash value is not registered, but the file path is registered for a different hash value, service program 50 removes the entry that includes the file path and the different hash value from file table 55. Then, service program 50 registers the new entry that includes the new hash value that was calculated in Step 1102 and the file path that was found in Step 1105 on file table 55. However, it should be noted that service program 50 does not remove other entries in the file table 55 when the hash value includes any other file paths that correspond to the hash value. For example, when there are multiple instances of an identical file stored in the storage system, it is desirable only to store one actual instance of the data of the file to reduce the overall amount of data stored in the storage system 1. Thus, multiple file paths (i.e., file IDs) might be linked to the stored data represented by the hash value. When a host computer modifies an existing file, storage system 1 receives new file data for the existing file path. The storage system stores the new file data and also registers the existing file path with a new hash value as a new entry for the new file data. Then, the storage system removes the old entry for the file path that included the old hash value. However, as previously explained above with respect to FIG. 6, other entries with different file paths could still exist for the old hash value, and so the storage system will keep these entries, and if the file modified is the first listed path, then when this entry is deleted, the second listed path becomes the first listed path for the old hash value, and is linked to the old data.

Step 1116: Service program 50 registers the new entry on host table 54 in an entry that includes the new hash value determined in Step 1102 and the host group that was determined in Step 1101.

Step 1117: Service program 50 registers the new entry that includes the new hash value and default Action on Action Table 56.

Step 1118: Service program 50 stores the file that was received in Step 1100 as a new file within the storage system.

FIG. 12 illustrates an example of a process to execute actions, such as when an information leakage has been detected.

Step 1200: Service program 50 refers to action table 56 and identifies an Action ID 231 for the hash value of the file. Then, service program 50 refers to the Action ID 240 within action definition table 53 to determine the type of action to take.

Step 1201: Service program 50 checks whether the Action ID 240 indicates logging. If the Action ID indicates logging then the process goes to Step 1202; otherwise, the process goes to Step 1203.

Step 1202: Service program 50 creates a log data and sends the log data to the destination 242 that is defined for the Action ID 240 within action definition table 53.

Step 1203: Service program 50 checks whether the Action ID 240 indicates sending e-mail. If the Action ID 240 indicates sending e-mail then the process goes to Step 1204; otherwise the process goes to Step 1205.

Step 1204: Service program 50 creates an e-mail message and sends the e-mail message to the destination 242 that is defined for the Action ID within action definition table 53.

Step 1205: Service program 50 checks whether the Action ID 240 indicates SNMP. If the Action ID indicates SNMP then proceed to Step 1206 otherwise proceed to Step 1207.

Step 1206: Service program 50 creates a SNMP Trap message and sends it to the destination 242 that is defined for the Action ID within action definition table 53.

Step 1207: Service program 50 executes actions other than logging, mail, and SNMP.

FIG. 13 illustrates an example of a process to add a new host and change an action using management interface 95 as provided by management service program 57.

Step 1300: An administrator opens a management window 93 to display a registration table 250.

Step 1301: Management service program 57 retrieves file information from file table 55, host information from host table 54, and action information from action table 56 for each hash value in registration table 250.

Step 1302: Management service program 57 displays the retrieved information to the administrator in registration table 250.

Step 1303: The administrator activates the Add New Host button 254, and then management service program 57 opens the second management window 94 to display the Add New Host table 260. The administrator chooses a new host group and activates the Select button 261.

Step 1304: Management service program 57 registers the selected host group on host table 54.

Step 1305: To change an action, the administrator activates the Change Action button 255, and then management service program 57 displays a third management window (not shown in FIG. 9) so that the administrator is able to select another action ID, such as from a list of available actions that may be taken.

Step 1306: Management service program 57 updates action table 56.

FIG. 14 illustrates an example of a process to detect information leakage executed by asynchronous detection program 51. Under the asynchronous detection technique of the invention, the storage system checks for information leakage after files have already been stored to the storage system. For example, this enables the storage system to perform the leakage detection function during non-peak periods, thereby increasing overall performance compared to the synchronous technique described above.

Step 1400: Asynchronous detection program 51 scans the storage system's file system which is maintained by the storage control software 49 to find any new or updated files that have been stored in storage system 1 since the last scan was performed.

Step 1401: Asynchronous detection program 51 determines whether there is any new file or updated file was found in Step 1400. If a new file or updated file is found, then the process goes to Step 1402. Otherwise, if no new or updated files were found, the process goes back to Step 1400 to check the file system during the next time period. For example, Step 1400 might be performed on an hourly basis, daily basis, etc., depending on the particular storage environment.

Step 1402: When a new or updated file is found, asynchronous detection program 51 checks an identification of the host computer that owns the file using meta data 110 of the file, and checks the host group of the host computer using host group definition table 52.

Step 1403: Asynchronous detection program 51 calculates a hash value of the file.

Step 1404: Asynchronous detection program 51 refers to host table 54 for determination as to whether the calculated hash value for the file is already registered.

Step 1405: Asynchronous detection program 51 checks whether the calculated hash value is already registered on host table 54. If the hash value is already registered on the table 54, then the process goes to Step 1410; otherwise, the process goes to Step 1406.

Step 1406: If the hash value is not registered on the host table, the asynchronous detection program 51 checks whether the file path of the file is already registered for another hash value on file table 55. If the file path of the file is already registered for the other hash vale on the table then the process goes to Step 1415; otherwise the process goes to Step 1407.

Step 1407: When the hash value is not registered on the host table or the file table, asynchronous detection program 51 registers the hash value calculated in step 1403 and the host group determined in Step 1402 on host table 54.

Step 1408: Asynchronous detection program 51 registers the hash value of the file and the file path of the file on file table 55.

Step 1409: Asynchronous detection program 51 registers the hash value of the file and a default action on action table 56.

Step 1410: When the hash value calculated in Step 1403 is already registered in host table 54, asynchronous detection program 51 goes to Step 1410 to check whether the host computer determined in Step 1402 is already registered for the hash value on host table 54. If the host computer is already registered for the hash value on host table 54, then the process goes to Step 1411; otherwise, the file is determined to be information leakage, and the process goes to Step 1413 for carrying out an action, as described above with respect to FIG. 12.

Step 1411: Asynchronous detection program 51 checks whether the file path of the file is already registered for the hash value on file table 55. If the file path of the file is already registered for the hash value on the file table 55 then the process goes to Step 1414; otherwise, the process goes to Step 1412.

Step 1412: Asynchronous detection program 51 registers the file path of the file for the hash value on file table 55.

Step 1413: Asynchronous detection program 51 determines that the file is an information leak and executes the process to execute actions, as described above with respect to FIG. 12.

Step 1414: Asynchronous detection program 51 discards the file data. Further, a direct comparison (e.g., bit-to-bit, or the like) of the data may be conducted here or earlier in order to ensure that the data already stored on the storage system is exactly the same as the data to be discarded before the data is actually discarded. This can eliminate the slim possibility of having matching hash codes for different actual data.

Step 1415: When the hash value calculated in Step 1403 is not registered, but the file path is registered, asynchronous detection program 51 removes the entry that includes the file path and the other hash value from file table 55. However, asynchronous detection program 51 keeps entries that include other file paths that are related to the hash value if any. Then, asynchronous detection program 51 registers on file table 55 the new entry that includes the new hash value that was calculated in Step 1403 and the file path that was found in Step 1406. However, it should be noted that service program 50 does not remove other entries in the file table 55 when the hash value includes any other file paths that are corresponded to the hash value. For example, when there are multiple instances of an identical file stored in the storage system, it is desirable only to store one actual instance of the data of the file to reduce the overall amount of data stored in the storage system 1. Thus, multiple file paths (i.e., file IDs) might be linked to the stored data represented by the hash value, as described above with respect to FIGS. 6 and 11.

Step 1416: Asynchronous detection program 51 registers on host table 54 the new entry that includes the new hash value determined in Step 1403 and the host group that was determined in Step 1402.

Step 1417: Asynchronous detection program 51 registers the new entry that includes the new hash value and a default action on action table 56.

### SECOND EMBODIMENTS

The above described invention can also be used in storage system 1 for detecting information leakage not only in file data but also in block data, such as data stored using SCSI or other block-type protocols. The second embodiments of the invention illustrate an example of how the invention may be applied in a block-based system. As large parts of the second embodiments are the same as those described above for the first embodiments, only the differences need be described below.

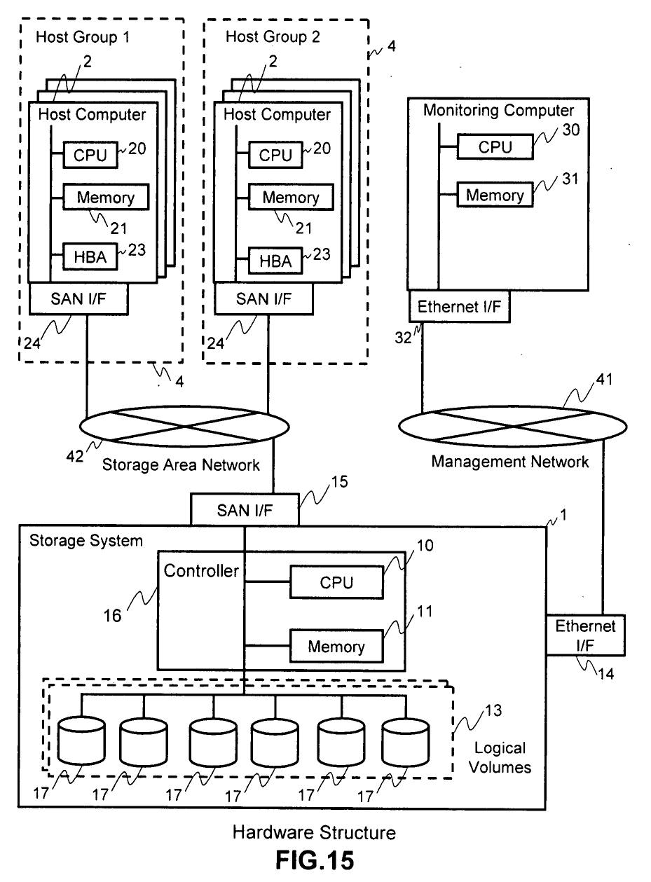

FIG. 15 illustrates an example of a physical hardware architecture of an information system of the second embodiments. In this embodiment, each host computer 2 and storage system 1 is connected through a SAN (Storage Area Network) 42. Storage system 1 includes at least one SAN interface 15 that is used for connecting to SAN 42. Host computer 2 includes at least one HBA (Host Bus Adaptor) 23 and at least one SAN interface 24 that is used for connecting to SAN 42. As discussed above, management computer 3 may communicate with storage system 1 via the same network as host computer 2, but in the preferred embodiment, a separate management network 41 is provided.

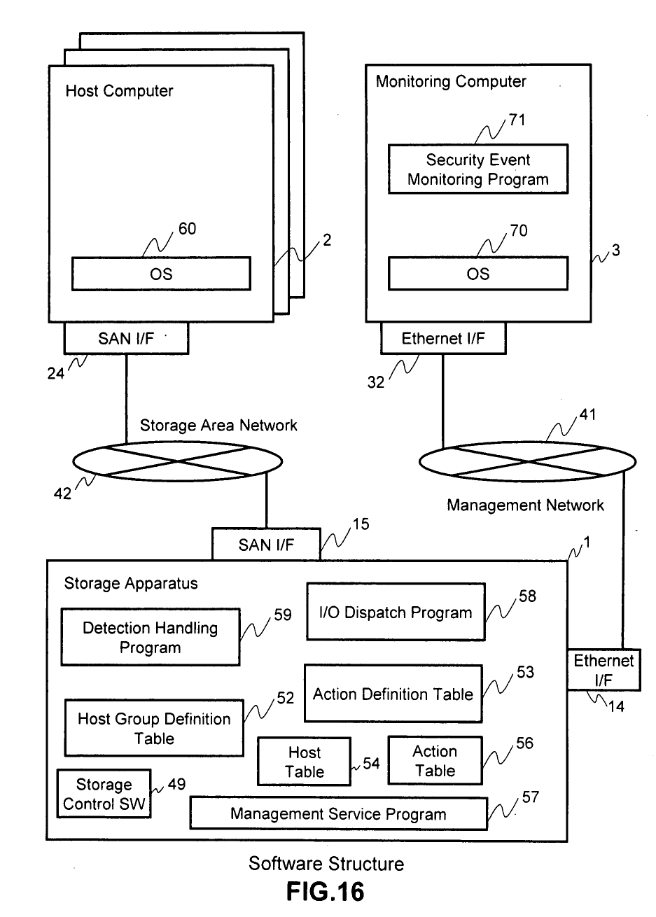

FIG. 16 illustrates an example of a logical software architecture of this embodiment. Software on the storage system 1 includes an I/O dispatch program 58 that receives various types of I/O requests from host computer 2 and that sends responses to host computer 2 in response to the I/O requests. I/O dispatch program 58 invokes other programs or subroutines according to the I/O requests received, as described below.

Storage system 1 also includes a detection handling program 59 that is invoked by I/O dispatch program 58 to perform the process to detect information leakage in synchronization with the process to handle SCSI Write requests from host computers 2. When detection handling program 59 receives write/update data from host computer 2, detection handling program 59 checks whether the same data is already stored within storage system 1 by another host computer 2. Detection handling program 59 also checks whether the same data was already registered for another host computer 2 by the administrator. If the same data was already stored or registered, detection handling program 59 executes an action, as described below. Detection handling program 59 uses hash values of data to compare data, as in the first embodiment, but could also or alternatively use other algorithms or comparison methods other than hash values.

As with the first embodiments, host table 54 is included for holding hash values of data and host groups that are registered as owners of data. Using host table 54, detection handling program 59 checks whether a certain data chunk is already stored within storage system 1. Detection handling program 59 also checks the owners of the data using this table. Host groups listed for each hash value of the data in this table are owners of the data. The first host group that stores new data is usually presumed to be the owner of the data. However, administrators can also configure this table via management service program 57 as was described for the first embodiments.

Action table 56 holds hash values of data and identifications of actions as with the first embodiments. When detection handling program 59 detects information leakage, it executes actions indicated by the action identifications 231. Actual actions are defined within action definition table 53, as in the first embodiments. The second embodiments do not include a file table 55, since the second embodiments are used in block-based storage environments, rather than file-based.

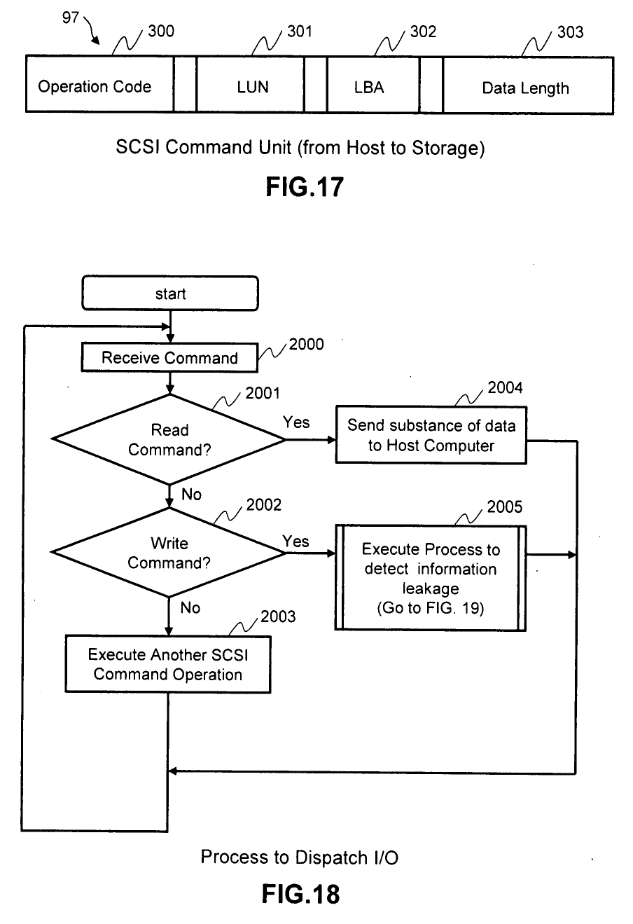

FIG. 17 illustrates the typical data structure of a SCSI command unit 97. Host computer and storage system communicate with each other using SCSI protocol via SAN. Host computers 2 issue requests using SCSI command units 97, to enable host computers 2 to transmit data to storage system 1 or receive data from storage system 1. The SCSI command unit 97 of FIG. 17 includes an operation code field 300 that indicates a type of request (for example, Read, Write, Reserve, Release, etc.). LUN field 301 indicates a target volume LUN of the request. LBA field 302 indicates an address within the target volume. Data Length field 303 indicates a data length of the data that is transferred between a host computer 2 and storage system 1 after SCSI command unit 97. Thus, the data that is transferred is the content for which a new hash value is calculated and compared with existing hash values previously calculated for existing data stored in the storage system.

FIG. 18 illustrates an example of a process to respond to SCSI I/O command, as executed by I/O dispatch program 58.

Step 2000: I/O dispatch program 58 receives a SCSI command unit from a host computer 2.

Step 2001: I/O dispatch program 58 checks the operation code 300 to determine whether the command is a Read command. If the command is for a Read command, then the process goes to Step 2004; otherwise, the process goes to Step 2002.

Step 2002: I/O dispatch program 58 checks whether the command is a Write command. If the command is a Write command then the process goes to Step 2005; otherwise, the process goes to Step 2003.

Step 2003: I/O dispatch program 58 also executes commands other than Read and Write commands, so if the command is not a Read or Write command, then one of the other commands, as identified in operation code 300, is executed.

Step 2004: When the command is a Read command, I/O dispatch program 58 responds by sending data that corresponds to the data requested by the host computer in the Read command.

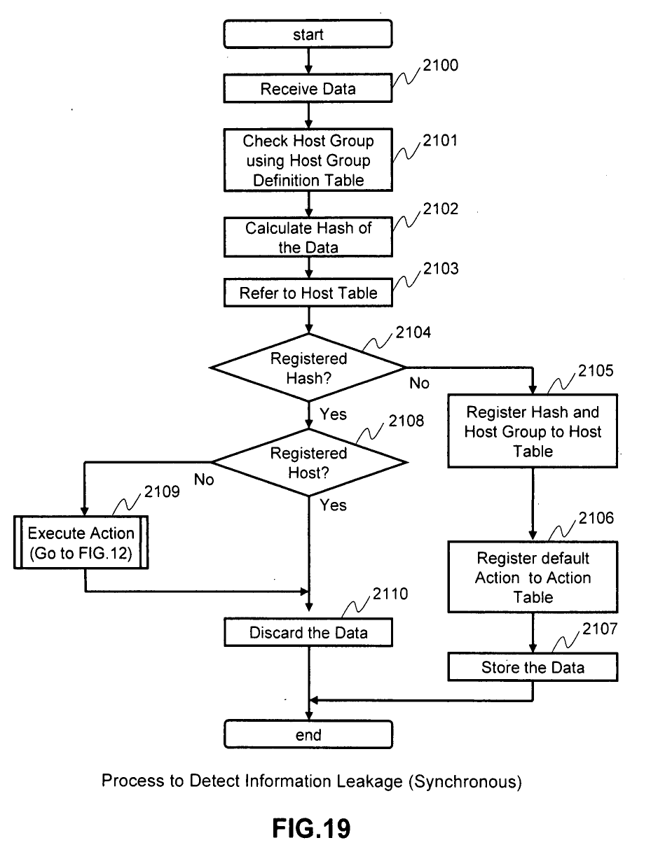

Step 2005: When the command is a Write command, I/O dispatch program 58 invokes detection handling program 59, according to the process set forth in FIG. 19.

FIG. 19 illustrates an example of a process to detect information leakage in the second embodiments, as executed by detection handling program 59.

Step 2100: Detection handling program 59 receives the SCSI write data.

Step 2101: Detection handling program 59 checks the host group 4 of the host computer 2 that sent the data to storage system 1 using host group definition table 52.

Step 2102: Detection handling program 59 calculates a hash value for the newly-received data.

Step 2103: Detection handling program 59 refers to host table 54.

Step 2104: Detection handling program 59 checks whether the hash value calculated in Step 2102 is already registered on host table 54. If the hash value is already registered on host table 54, then the process goes to Step 2108; otherwise, the process goes to Step 2105.

Step 2105: Detection handling program 59 registers the hash value calculated in Step 2102 and the host group ID obtained in step 2102 on host table 54.

Step 2106: Detection handling program registers the hash value of the data and a default action on action table 56.

Step 2107: Detection handling program 59 stores the data within storage system.

Step 2108: If the hash value calculated in Step 2102 is a registered hash, detection handling program 59 checks whether the host computer is already registered for the hash value on host table 54. If the host computer that sent the Write command is already registered for the hash value on the table, then the process goes to Step 2110. Otherwise, the data is not registered and is assumed to be information leakage, so the process goes to Step 2109.

Step 2109: The data is assumed to be information leakage, and the detection handling program 59 executes the process to execute actions, as described above with reference to FIG. 12.

Step 2110: Detection handling program 59 discards the data, since it is already stored in the storage system. Because hash values may in rare instances be the same for different data, an additional comparison of the new data with the data already stored in the storage system may be conducted either at this point, or in Step 2104. This will ensure that the discarded data is actually already stored in the storage system. As discussed above, the comparison may be conducted as a bit-to-bit comparison, byte-to-byte, or through another type of algorithm, and may be conducted by software or hardware. Further, the management of the de-duplication of the data in the storage system can be conducted as taught by the Zhu patent, which was incorporated herein by reference above. Accordingly, the details do not need to be repeated here.

Thus, it may be seen that the invention is useful for storage systems and host computers that are connected to storage systems to detect information leakage. The storage system can check the owners of data synchronously, such as at the time the data is stored, or asynchronously. The invention provides a mechanism that detects possible information leakage, especially unauthorized information sharing among several divisions of organization that use a consolidated storage system. The invention can also provide a mechanism that notifies a security monitoring service of information leakage when storage system detects information leakage. Additionally, the invention is able to facilitate the use of de-duplication in a storage system, and is compatible for use in a Contents Addressed Storage (CAS) system in which data is stored according to the content of the data itself, whereby a unique address is created for each chunk of data based upon a hash value calculated from the content of the data. For example, US Pat. Appl. Pub. No. 2002/0042796A1 to Tomohiro Igakura, entitled “File Managing System”, the disclosure of which is incorporated herein by reference in its entirety, discusses a system in which hash values are used to determine file IDs for files according to the content of the files.

Further, while specific embodiments have been illustrated and described in this specification, those of ordinary skill in the art appreciate that any arrangement that is calculated to achieve the same purpose may be substituted for the specific embodiments disclosed. This disclosure is intended to cover any and all adaptations or variations of the present invention, and it is to be understood that the above description has been made in an illustrative fashion, and not a restrictive one. Accordingly, the scope of the invention should properly be determined with reference to the appended claims, along with the full range of equivalents to which such claims are entitled.

What is claimed:

1. A storage system comprising:
a controller in communication with one or more storage devices, said controller controlling input/output (I/O) operations to said one or more storage devices,
wherein when said controller receives write data targeting said one or more storage devices, said controller compares a content of said write data with a content of existing data already stored in said one or more storage devices,
wherein, when the content of the write data matches the content of the existing data, the storage system determines an owner of the write data and an owner of the existing data that has the matching content, and
wherein said storage system performs a specified action when the owner of the write data is not registered as the owner of the existing data.

2. The storage system according to claim 1,
wherein said controller compares the content of said write data with the content of the existing data by calculating a first hash value for said write data and comparing the first hash value with second hash values calculated for the existing data stored in the storage system

3. The storage system according to claim 1,
wherein said controller compares the content of said write data with the content of the existing data asynchronously after the write data has been stored in the storage system.

4. The storage system according to claim 1,
wherein said specified action includes sending a notification to a management computer in communication with said storage system, and
wherein said write data is discarded.

5. The storage system according to claim 1, further comprising a graphic user interface displayed at a computer that enables a user to manually register an owner for the existing data.

6. The storage system according to claim 1,
wherein when said write data is the same as the existing data already stored in the storage system, said storage system saves a path for the write data, and correlates the path for the write data with an existing path for the existing data, and then discards the write data, thereby performing a de-duplication for the storage system.

7. The storage system according to claim 1,
wherein said write data is a first file having a first file name, and said existing data is a second file having a second file name different from said first file name, and
wherein said controller identifies said first file as having the same content as the second file even though the first file has a different name from the second file.

8. The storage system according to claim 1,
wherein the storage system determines the owner of the write data by identifying a location from which the write data was received and by determining a first host group correlated to the identified location,
wherein the storage system determines the owner of the existing data that has the matching content by determining any host groups registered as owners of the existing data, and
wherein when the first host group is not registered as an owner of the existing data, an information leakage is assumed, and the storage system performs the specified action.

9. A storage system comprising:
a controller for processing I/O operations received one or more host computers, said I/O operations being directed to a plurality of storage devices in communication with said controller,
wherein said storage system receives write data from a particular one of said one or more host computers,
wherein said storage system calculates a first hash value for the write data and compares the first hash value with second hash values calculated for existing data stored in the storage system,
wherein when said first hash value matches one of said second hash values, said storage system determines an owner of the write data by identifying a location from which the write data was received and by determining a first host group correlated to the identified location,
wherein the storage system determines an owner of the existing data that has the matching content by determining any host groups registered as owners of the existing data, and
wherein when the first host group determined to have sent the write data is not registered as an owner of the existing data, an information leakage is assumed, and the storage system performs a specified action.

10. The storage system according to claim 9,
wherein said controller compares the content of said write data with the content of the existing data asynchronously after the write data has been stored in the storage system.

11. The storage system according to claim 9,
wherein said specified action includes sending a notification to a management computer in communication with said storage system, and
wherein said write data is discarded.

12. The storage system according to claim 9, further comprising a graphic user interface displayed at a computer that enables a user to manually register an owner for the existing data.

13. The storage system according to claim 9,
wherein said write data is a first file having a first file name, and said existing data is a second file having a second file name different from said first file name, and
wherein said controller identifies said first file as having the same content as the second file even though the first file has a different name from the second file.

14. The storage system according to claim 9,
wherein said storage system saves a path for the new data, and correlates the path for the new data with an existing path for the existing data, and then discards the new data, thereby performing a de-duplication for the storage system.

15. An information system comprising:
a storage system in communication with one or more first host computers and one or more second host computers, said one or more first host computers being members of a first host group and said one or more second host computers being members of a second host group,
wherein said storage system calculates a first hash value for new data received from a particular one of said first or second host computers,
wherein said storage system compares the first hash value with second hash values calculated for existing data stored in the storage system,
wherein when said first hash value matches one of said second hash values, said storage system determines any host groups registered for existing data corresponding to said existing hash value, and
wherein when said particular one of said first or second host computers that sent the new data is not a member of any host groups registered for the existing data corresponding to said one of said second hash values, said storage system performs a specified action.

16. The information system according to claim 15,
wherein said storage system compares the first hash value with the second hash values calculated for the existing data stored in the storage system asynchronously after the new data has been stored in the storage system.

17. The information system according to claim 15,
wherein said specified action includes sending a notification to a management computer in communication with said storage system and discarding said new data.

18. The information system according to claim 15, further comprising a graphic user interface that enables a user to manually register a host group for the existing data.

19. The information system according to claim 15,
wherein said storage system saves a path for the new data, and correlates the path for the new data with an existing path for the existing data, and then discards the new data, thereby performing a de-duplication for the storage system.

20. The information system according to claim 15,
wherein said new data is a first file having a first file name, and said existing data is a second file having a second file name different from said first file name, and
wherein said controller identifies said first file as having the same content as the second file even though the first file has a different name from the second file.
